(19) United States
(12) Patent Application Publication
(10) Pub. No.: US 2007/0202365 A1
(43) Pub. Date: Aug. 30, 2007

(54) Lithium secondary battery

(76) Inventors: Shouichirou Sawa, Moriguchi-shi (JP); Kazuyuki Satou, Usa-shi (JP); Atsushi Fukui, Moriguchi-shi (JP); Yasuyuki Kusumoto, Moriguchi-shi (JP); Maruo Kamino, Moriguchi-shi (JP)

Correspondence Address: KUBOVCIK & KUBOVCIK, SUITE 710, 900 17TH STREET NW, WASHINGTON, DC, 20006, US

(21) Appl. No.: 11/709,252

(22) Filed: Feb. 22, 2007

(30) Foreign Application Priority Data
Feb. 28, 2006 (JP) 2006-053127

(51) Int. Cl. H01M 14/00; H01M 4/58; H01M 4/62

(52) U.S. Cl. 429/9; 429/60; 429/218.1; 429/231.95; 429/217

(57) ABSTRACT

In a lithium secondary battery using negative electrode active material particles containing silicon, excellent charge-discharge characteristics are achieved and swelling of the negative electrode is minimized. A lithium secondary battery has a positive electrode containing a positive electrode active material, a negative electrode containing an active material layer and a current collector made of a conductive metal foil, and a non-aqueous electrolyte. The active material layer has a binder and active material particles containing silicon, and is formed by sintering the active material layer on a current collector surface in a non-oxidizing atmosphere. The active material particles have an average particle size of from 7.5-15 μm and a particle size distribution such that 60 volume % or more of the active material particles falls within the ±40% range of the average particle size, and the lithium secondary battery has a negative/positive electrode capacity ratio of 1.7 or greater.

### BACKGROUND OF THE INVENTION

1. Field of the Invention

The present invention relates to a lithium secondary battery that uses active material particles containing silicon as a negative electrode active material.

2. Description of Related Art

In recent years, a lithium secondary battery that uses a non-aqueous electrolyte and that performs charge-discharge operations by transmitting lithium ions between its positive and negative electrodes has been in use as a new type of high power, high energy density secondary battery.

Because of their high energy density, lithium secondary batteries have been widely used as power sources for portable electronic devices related to information technology, such as mobile telephones and notebook computers. It is expected that such portable devices will become even smaller and have more functions in the future, and thus there is a pronounced demand for lithium secondary batteries, used as their power sources, with higher energy densities.

An effective means for increasing the energy density of a battery is to use a material that has a larger energy density as the active material. Recently, there have been proposals and investigations into the use, in lithium secondary batteries, of materials containing such elements as Si, Sn, and Al that are capable of intercalating lithium through an alloying reaction with lithium as a negative electrode active material that has a higher energy density, in place of graphite, which has been in commercial use.

In the electrode that uses a material capable of alloying with lithium as the active material, however, the active material expands and shrinks in volume during the intercalation and deintercalation of lithium, causing the active material to pulverize or peel off from the current collector. As a result, the current collection performance in the electrode degrades, and the discharge cycle performance of the battery becomes poor.

To resolve the above-mentioned problems, Japanese Published Unexamined Patent Application No. 2002-260637, for example, has proposed a negative electrode employing a material containing silicon as the negative electrode active material that alloys with lithium, the negative electrode being provided with a mixture layer that comprises the just-mentioned active material and a binder on a surface of a conductive metal foil current collector having surface irregularities and formed by sintering the mixture layer in a non-oxidizing atmosphere. The negative electrode is said to exhibit high current collection performance in the electrode due to the resulting strong adhesion between the mixture layer and the current collector, thus achieving good charge-discharge cycle performance. In addition, Japanese Published Unexamined Patent Application No. 2004-22433, for example, has proposed that the use of silicon particles, used as the negative electrode active material, that have an average particle size of from 1 μm to 10 μm and a particle size distribution such that 60 volume % or more of the particles fall within the range of from 1 μm to 10 μm can minimize degradation of the current collection performance in the electrode, improving charge-discharge cycle performance.

These techniques, however, have still been considered unsatisfactory, and further higher charge-discharge cycle performance has been demanded.

### BRIEF SUMMARY OF THE INVENTION

Accordingly, it is an object of the present invention to provide a lithium secondary battery that has further improved charge-discharge characteristics, in a lithium secondary battery that uses active material particles containing silicon as the negative electrode active material.

In order to accomplish the foregoing and other objects, the present invention provides a lithium secondary battery comprising: a positive electrode comprising a positive electrode active material; a negative electrode comprising an active material layer and a current collector made of a conductive metal foil, the active material layer comprising a binder and active material particles that contain silicon, and being formed by sintering the active material layer on a surface of the current collector in a non-oxidizing atmosphere, the active material particles having an average particle size of from 7.5 μm to 15 μm and a particle size distribution such that 60 volume % or more of the active material particles falls within a ±40% range of the average particle size; and a non-aqueous electrolyte, wherein the lithium secondary battery has a negative/positive electrode capacity ratio of 1.7 or greater, the negative/positive electrode capacity ratio being defined as the ratio of negative electrode specific capacity/positive electrode specific capacity, wherein the negative electrode specific capacity is a negative electrode capacity per unit area that is obtained, using a three-electrode cell in which the negative electrode and Li oppose each other, by passing a current through the three-electrode cell so that the potential changes from 1 m V (vs. Li/Li⁺) to 1000 mV (vs. Li/Li⁺), and the positive electrode specific capacity is a positive electrode capacity per unit area that is obtained, using a three-electrode cell in which the positive electrode and Li oppose each other, by passing a current through the three-electrode cell so that the potential changes from 4.4 V (vs. Li/Li⁺) to 3.0 V (vs. Li/Li⁺).

According to the present invention, pulverization of the active material particles and degradation in the current collection performance in the electrode are prevented, and the charge-discharge cycle performance is improved while the expansion of the negative electrode is minimized.

### BRIEF DESCRIPTION OF THE DRAWINGS

FIG. 1 is a graph illustrating the relationship between number of cycles and capacity retention ratio of a battery A3 according to the invention;

FIG. 2 is a plan view illustrating a lithium secondary battery fabricated in the manner described in a later-described Example in the present invention;

FIG. 3 is a cross-sectional view of the lithium secondary battery of FIG. 2 taken along line III-III; and

FIGS. 4(a) and 4(b) are schematic views showing the relationship between the active material particles and the current collector, for illustrating the advantageous effects of the present invention.

### DETAILED DESCRIPTION OF THE INVENTION

A lithium secondary battery according to the present invention comprises a positive electrode containing a positive electrode active material, a negative electrode containing an active material layer and a current collector made of a conductive metal foil, and a non-aqueous electrolyte. The active material layer comprises a binder and active material particles containing silicon, and is formed by sintering the active material layer on a surface of the current collector in a non-oxidizing atmosphere. The active material particles have an average particle size of from 7.5 μm to 15 μm and a particle size distribution such that 60 volume % or more of the active material particles falls within the ±40% range of the average particle size. The lithium secondary battery has a negative/positive electrode capacity ratio of 1.7 or greater. The negative/positive electrode capacity ratio is defined as the ratio of negative electrode specific capacity/positive electrode specific capacity, wherein the negative electrode specific capacity is a negative electrode capacity per unit area that is obtained, using a three-electrode cell in which the negative electrode and Li oppose each other, by passing a current through the three-electrode cell so that the potential changes from 1 m V (vs. Li/Li⁺) to 1000 mV (vs. Li/Li⁺), and the positive electrode specific capacity is a positive electrode capacity per unit area that is obtained, using a three-electrode cell in which the positive electrode and Li oppose each other, by passing a current through the three-electrode cell so that the potential changes from 4.4 V (vs. Li/Li⁺) to 3.0 V (vs. Li/Li⁺).

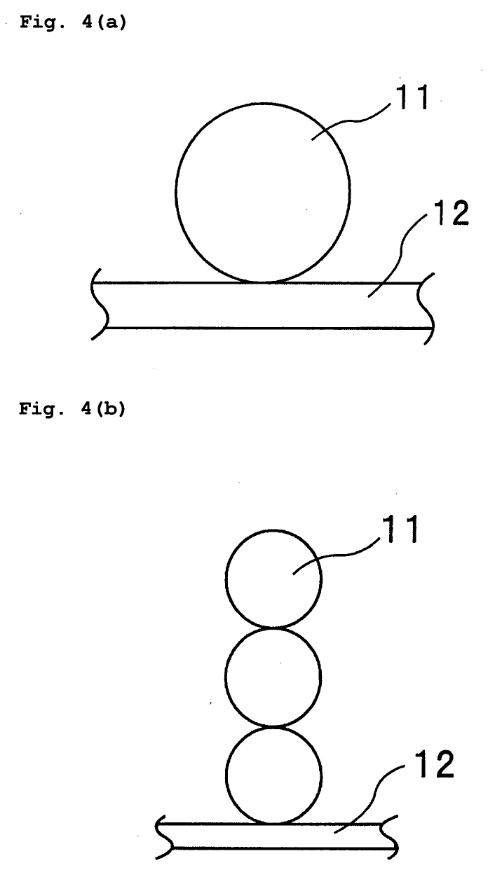

In the present invention, the average particle size of the active material particles is controlled to be within the range of from 7.5 μm to 15 μm. Controlling the average particle size to be 7.5 μm or greater serves to reduce the number of the particles per unit thickness of the active material layer accordingly, which means that the number of the particles that need to be brought into contact with each other in order to obtain current collection capability becomes smaller, and therefore, good current collection performance can be obtained. FIG. 4 is a schematic view for illustrating this mechanism. As illustrated in FIG. 4(b), when the average particle size of the active material particles 11 is small, the three active material particles 11 depicted in the figure need to be brought into contact with one another in order to make contact with the current collector 12. In contrast, as illustrated in FIG. 4(a), when the average particle size of the active material particles 11 is large, only one active material particle 11 need to make contact with the current collector 12. Thus, by increasing the average particle size of the active material particles in this way, it becomes possible to enhance the current collection performance of the negative electrode and to increase the amount of the active material particles that contribute to charge-discharge operations, achieving good charge-discharge cycle performance of the battery.

If the average particle size of the active material particles is greater than 15 μm, the filling density of the active material particles degrades because gaps within the active material layer correspondingly become greater. Moreover, such larger gaps that exist around the active material particles do not easily absorb the volumetric expansion of the active material particles that is caused by charging, and the expansion of the active material particles directly affects the expansion of the electrode, degrading the battery performance.

In the present invention, the active material particles have a particle size distribution such that 60 volume % of the active material particles falls within a ±40% range of the average particle size. The use of active material particles having such a sharp particle size distribution allows the active material particles to expand by approximately the same absolute amount of expansion during charge, making it possible to keep the electrode strength high and to maintain the current collection performance. Therefore, the charge-discharge cycle performance improves.

In the present invention, the negative/positive electrode capacity ratio (negative electrode specific capacity/positive electrode specific capacity) is controlled to be 1.7 or greater. If the negative/positive electrode capacity ratio is less than 1.7, the utilization factor of the negative electrode becomes high and the negative electrode expands greatly, so peeling of the active material particles from the current collector tends to occur easily, degrading the charge-discharge cycle performance.

Examples of active material particles containing silicon in the present invention include silicon particles and silicon alloy particles. Examples of silicon alloys include a solid solution of silicon and at least one other element, an intermetallic compound of silicon and at least one other element, and an eutectic alloy of silicon and at least one other element. Examples of the method for producing the alloys include arc melting, liquid quenching, mechanical alloying, sputtering, chemical vapor deposition, and baking. Specific examples of the liquid quenching include a single-roll quenching technique, a double-roller quenching technique, and various atomization techniques such as gas atomization, water atomization, and disk atomization.

The surfaces of the active material particles may be coated with a metal or the like. Examples of the method of coating include electroless plating, electroplating, chemical reduction technique, evaporation, sputtering, and chemical vapor deposition.

In the present invention, it is preferable that the active material particles containing silicon be particles of silicon alone, that is, silicon particles.

It is preferable that the negative electrode in the present invention be a negative electrode in which a negative electrode mixture layer comprising a negative electrode binder and the active material particles containing silicon is sintered on a surface of a conductive metal foil serving as a negative electrode current collector. Sintering the mixture layer on the current collector surface has the effect of significantly enhancing the adhesion of the active material particles with one another and the adhesion between the mixture layer and the current collector. For this reason, even when changes of the negative electrode active material in volume occur during lithium intercalation and deintercalation, it is possible to maintain the current collection performance of the mixture layer and to obtain excellent cycle performance.

It is particularly preferable that the negative electrode binder be thermoplastic. For example, when the negative electrode binder has a glass transition temperature, it is preferable that the heating process for sintering the negative electrode mixture layer on the negative electrode current collector surface be carried out at a temperature higher than the glass transition temperature. This enables the binder to thermally bond with the active material particles and the current collector, significantly improving the adhesion of the active material particles with each other and the adhesion between the mixture layer and the current collector. Consequently, the current collection performance within the electrode can be improved significantly, and further excellent cycle performance can be obtained.

In this case, it is preferable that the negative electrode binder remain without being decomposed completely even after the heating process. If the binder is completely decomposed after the heating process, the binding effect of the binder is lost, and therefore, the current collection performance to the electrode greatly lowers and the charge-discharge cycle performance becomes poor.

It is preferable that the sintering for disposing the negative electrode mixture layer on the current collector surface be carried out under an inert gas atmosphere, such as a vacuum, a nitrogen atmosphere, or an argon atmosphere. It is also possible to carry out the sintering under a reducing atmosphere such as a hydrogen atmosphere. It is preferable that the temperature of the sintering be lower than the temperature at which the binder resin starts to thermally decompose, because, as mentioned above, the negative electrode binder should preferably remain in the mixture layer without completely being decomposed. The sintering may be carried out by a discharge plasma sintering technique or hot pressing.

In the present invention, it is preferable that the negative electrode be fabricated by uniformly mixing and dispersing the negative electrode active material particles in a solution of the negative electrode binder to produce a negative electrode mixture slurry, and applying the resultant negative electrode mixture slurry onto a surface of a conductive metal foil serving as the negative electrode current collector. In the mixture layer thus formed with the use of the slurry in which the active material particles are uniformly mixed and dispersed in the binder solution, the binder is uniformly distributed around each active material particle. This makes it possible to obtain maximum benefit from the mechanical properties of the binder, so that the electrode strength can be increased and excellent charge-discharge cycle performance can be obtained.

In the present invention, the surface of the negative electrode current collector on which the negative electrode mixture layer is to be disposed should preferably have a surface roughness Ra of 0.2 μm or greater. The use of a conductive metal foil with such a surface roughness Ra of 0.2 μm or greater as the negative electrode current collector allows the negative electrode binder to get into the portions of the current collector surface in which surface irregularities exist, exerting an anchoring effect and thereby providing strong adhesion between the binder and the current collector. As a result, it becomes possible to prevent the peeling of the negative electrode mixture layer from the negative electrode current collector, which peeling is due to the expansion and shrinkage in volume of the active material particles that are associated with the lithium intercalation and deintercalation. In the case that the negative electrode mixture layer is disposed on both sides of the negative electrode current collector, it is preferable that both surfaces of the negative electrode current collector have a surface roughness Ra of 0.2 μm or greater.

It is preferable that the just-mentioned surface roughness Ra and mean spacing of local peaks S of the current collector have a relationship 100Ra≧S. Surface roughness Ra and mean spacing of local peaks S are defined in Japanese Industrial Standards (JIS B 0601-1994) and can be measured by, for example, a surface roughness meter.

To provide the current collector with a surface roughness Ra of 0.2 μm or greater, the conductive metal foil may be subjected to a roughening process. Examples of the roughening process include plating, vapor deposition, etching, and polishing. Plating and vapor deposition are techniques for roughing a surface of a metal foil by forming a thin film layer having irregularities on the metal foil surface. Examples of the plating include electroplating and electroless plating. Examples of the vapor deposition include sputtering, chemical vapor deposition, and evaporation. Examples of the etching include such techniques as physical etching and chemical etching. Examples of the polishing include polishing by sandpaper and polishing by blasting.

The current collector used in the present invention may be a metal foil made of a metal such as copper, nickel, iron, titanium, or cobalt, or may be an alloy foil made of a combination thereof.

It is particularly preferable that the negative electrode current collector have a tensile strength of more than 2.0 N/mm². By imparting such a high mechanical strength to the current collector, the stress that is caused by changes in volume of the negative electrode active material during lithium intercalation and deintercalation and that is applied to the negative electrode current collector can be alleviated, without causing destruction or plastic deformation of the negative electrode current collector. Thus, peeling of the mixture layer from the current collector is prevented, the current collection performance in the electrode is maintained, and excellent charge-discharge cycle performance can be obtained.

Although not particularly limited, the thickness of the negative electrode current collector is preferably within the range of from 10 μm to 100 μm.

The upper limit of the surface roughness Ra of the conductive metal foil negative electrode current collector in the present invention is not particularly limited. That said, because it is preferable that the thickness of the conductive metal foil be within the range of from 10 μm to 100 μm as noted above, the upper limit of the surface roughness Ra should accordingly be 10 μm or less.

In the negative electrode of the present invention, it is preferable that the negative electrode mixture layer thickness X, the negative electrode current collector thickness Y, and the surface roughness Ra satisfy the relations 5Y≧X and 250Ra≧X. If the thickness X of the negative electrode mixture layer exceeds either 5Y or 250Ra, the expansion and shrinkage in volume of the mixture layer during charge and discharge are so great that the irregularities of the current collector surface cannot maintain the adhesion between the mixture layer and the current collector, causing the mixture layer to peel off from the current collector.

The thickness X of the negative electrode mixture layer is preferably, but not particularly limited to, 1000 μm or less, and more preferably within the range of from 10 μm to 100 μm.

In the present invention, it is preferable that the negative electrode binder have a high mechanical strength and good elasticity. Even when the negative electrode active material changes in volume during the lithium intercalation and deintercalation, the use of a binder having good mechanical properties prevents the binder from being destroyed and allows the mixture layer to change in shape corresponding to the change in volume of the active material. Consequently, the current collection performance in the electrode is maintained, and excellent charge-discharge cycle performance can be obtained. Examples of a binder having such mechanical properties include a polyimide resin. Fluoropolymers such as polyvinylidene fluoride and polytetrafluoroethylene may also be suitably used.

In the present invention, it is preferable that the amount of the negative electrode binder be 5 weight % or greater of the total weight of the negative electrode mixture layer, and that the volume of the negative electrode binder be 5% or greater of the total volume of the negative electrode mixture layer. It should be noted here that the total volume of the negative electrode mixture layer means the total of the volumes of the materials contained in the mixture layer, such as the active material and the negative electrode binder, and that it does not include the volume of voids in the mixture layer if such voids exist in the mixture layer. If the amount of the binder is less than 5 weight % of the total weight of the mixture layer and the volume of the binder is less than 5% of the total volume of the mixture layer, the adhesion within the electrode that is provided by the binder will be insufficient because the amount of the binder is too small relative to the negative electrode active material. On the other hand, if the amount of the negative electrode binder is too large, the resistance within the electrode becomes large, making initial charging difficult. Therefore, it is preferable that the amount of the negative electrode binder be 50 weight % or less of the total weight of the negative electrode mixture layer and that the volume of the negative electrode binder be 50% or less of the total volume of the negative electrode mixture layer.

In the negative electrode of the invention, the negative electrode mixture layer may also contain conductive powder. This is because the addition of conductive powder results in the formation of a conductive network around the active material particles, and as a result, the current collection performance of the electrode improves further. As the conductive powder, the same material as the conductive metal foil can be favorably used. Specific examples include a metal such as copper, nickel, iron, titanium, or cobalt, or an alloy or mixture made of a combination thereof. Copper powder is particularly preferably used as a metal powder. Conductive carbon powder is also a preferred material.

It is preferable that the amount of the conductive powder contained in the negative electrode mixture layer be 50 weight % or less of the total weight of the negative electrode mixture layer, and the volume occupied by the conductive powder be 20% or less of the total volume of the negative electrode mixture layer. If the amount of the conductive powder added is too large, the relative proportion of the negative electrode active material in the negative electrode mixture layer correspondingly reduces, and consequently the charge-discharge capacity of the negative electrode decreases. Moreover, if that is the case, the strength of the mixture layer lowers and the charge-discharge cycle performance degrades because the relative proportion of the binder to the active material and the conductive agent reduces in the total amount of the mixture layer.

The average particle size of the conductive powder is preferably, but not particularly limited to, 100 μm or less, more preferably 50 μm or less, and most preferably 10 μm or less.

An example of the positive electrode active material in the present invention is a lithium-transition metal composite oxide. The lithium-transition metal composite oxide may be any lithium-transition metal composite oxide that can be used as a positive electrode active material of lithium secondary batteries. Examples thereof include LiCoO₂₁ LiNiO₂, LiMn₂O₄, LiMnO₂, LiCu_{0.5}Ni_{0.5}O₂, and LiNi_{0.33}CO_{0.33}Mn_{0.34}O₂. Particularly preferred is LiCoO₂, as well as a lithium-transition metal composite oxide having a layered structure and containing Ni, Mn, and Co as transition metals.

It is preferable that the average particle size of the lithium-transition metal composite oxide (the average particle size of its secondary particles) be 20 μm or less. If the average particle size exceeds 20 μm, the distance of diffusion of the lithium in the lithium-transition metal composite oxide particles is large, and thus the charge-discharge cycle performance tends to degrade.

It is preferable that the positive electrode in the lithium secondary battery of the present invention be such that a positive electrode mixture layer that contains a lithium-transition metal composite oxide as the positive electrode active material, a positive electrode conductive agent, and a positive electrode binder is disposed on a positive electrode current collector made of a conductive metal foil.

The positive electrode binder may be composed of any binder as long as it does not dissolve in the solvent of the non-aqueous electrolyte. Examples thereof include a fluororesin such as a polyvinylidene fluoride, a polyimide-based resin, and a polyacrylonitrile.

Various known conductive agents may be used as the positive electrode conductive agent. For example, conductive carbon materials may be used. Particularly preferable examples include acetylene black and Ketjen Black.

The conductive metal foil used as the positive electrode current collector may be made of any material as long as it does not dissolve in the electrolyte solution at a potential that is applied to the positive electrode during charge and discharge. A preferable example is aluminum foil.

Examples of the solvent of the non-aqueous electrolyte in the present invention include, but are not particularly limited to: cyclic carbonates such as ethylene carbonate, propylene carbonate, butylene carbonate, and vinylene carbonate; chain carbonates such as dimethyl carbonate, methyl ethyl carbonate, and diethyl carbonate; esters such as methyl acetate, ethyl acetate, propyl acetate, methyl propionate, ethyl propionate, and γ-butyrolactone; ethers such as 1,2-dimethoxyethane, 1,2-diethoxyethane, tetrahydrofuran, 1,2-dioxane, and 2-methyltetrahydrofuran; nitrites such as acetonitrile; and amides such as dimethylformamide. These solvents may be used either alone or in combination. Particularly preferred is a mixed solvent of a cyclic carbonate and a chain carbonate.

Examples of the solute of the non-aqueous electrolyte in the present invention include, but are not particularly limited to: lithium compounds represented by the chemical formula LiXF_{y} (wherein X is P, As, Sb, B, Bi, Al, Ga, or In; and y is 6 when X is P, As, or Sb; or y is 4 when X is B, Bi, Al, Ga, or In), such as LiPF₆, LiBF₄, and LiAsF₆; and lithium compounds such as LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiClO₄, Li₂B₁₀Cl₁₀, and Li₂B₁₂Cl₁₂. Among them, LiPF₆ is particularly preferable.

Examples of the electrolyte include a gelled polymer electrolyte in which an electrolyte solution is impregnated in a polymer electrolyte such as polyethylene oxide, polyacrylonitrile, or the like, and inorganic solid electrolytes such as LiI or Li₃N. There is no limitation to the electrolyte of the lithium secondary battery of the present invention, and any type of electrolyte may be used as long as it does not cause the lithium compound, which is used as the solute for providing ionic conductivity, and the solvent, which is used for dissolving and retaining the solute, to be decomposed at a voltage in charging and discharging operations of the battery or at a voltage during the storage of the battery.

In the present invention, it is preferable that carbon dioxide be dissolved in the non-aqueous electrolyte. Carbon dioxide dissolved in the non-aqueous electrolyte enables the lithium secondary battery to achieve good charge-discharge cycle performance. It is believed that the carbon dioxide forms a surface film on the surface of the negative electrode active material, allowing the lithium intercalation/deintercalation reaction at the negative electrode active material surface to take place smoothly.

It is preferable that the amount of carbon dioxide dissolved be 0.01 weight % or greater, more preferably 0.05 weight % or greater, and still more preferably 0.1 weight % or greater. The upper limit is not particularly restricted, and the saturation amount of carbon dioxide that can be dissolved should be considered as the upper limit.

The present invention makes available a lithium secondary battery that achieves excellent charge-discharge characteristics and at the same time minimizes the battery swelling resulting from charge-discharge operations, the lithium secondary battery employing active material particles containing silicon as a negative electrode active material.

### EXAMPLES

Hereinbelow, the present invention is described in further detail based on examples thereof. It should be understood, however, that the present invention is not limited to the following examples but various changes and modifications are possible without departing from the scope of the invention.

### Experimental Example 1

### Preparation of Negative Electrode

Silicon powder (purity: 99.9%) having an average particle size of 7.5 μm, which serves as a negative electrode active material, and a thermoplastic polyimide having a glass transition temperature of 190° C. and a density of 1.1 g/cm³, which serves as a negative electrode binder, were mixed together with N-methyl-2-pyrrolidone as a dispersion medium so that the weight ratio of the active material to the binder became 90:10, to thus prepare a negative electrode mixture slurry.

The resultant negative electrode mixture slurry was applied onto one side (roughened side) of an electrolytic copper foil (thickness: 35 μm, Ra=0.5 μm) which was used as a negative electrode current collector, and then dried. The resultant article was cut out into a 30 mm×30 mm rectangle shape, then pressure-rolled, and thereafter subjected to a heating process for sintering at 400° C. for 1 hour under an argon atmosphere, to thus prepare a negative electrode C1.

A negative electrode C2 was prepared in the same manner as negative electrode C1, except that silicon powder having an average particle size of 10 μm was used as the negative electrode active material.

A negative electrode C3 was prepared in the same manner as negative electrode C1, except that silicon powder having an average particle size of 15 μm was used as the negative electrode active material.

A negative electrode C4 was prepared in the same manner as negative electrode C1, except that silicon powder having an average particle size of 5.5 μm was used as the negative electrode active material.

A negative electrode C5 was prepared in the same manner as negative electrode C1, except that silicon powder having an average particle size of 20 μm was used as the negative electrode active material.

Measurement of Particle Size Distribution

The average particle size and the particle size distribution of each of the negative electrodes prepared in the manner described above were measured using a diffraction particle size distribution analyzer SALD-2000J made by Shimadzu Corp.

Preparation of Positive Electrode

Li₂CO₃ and CoCO₃ were used as the starting materials. They were weighed so that the atomic ratio Li:Co became 1:1, followed by mixing them in a mortar. Thereafter, the resultant mixture was press-formed by pressing it with a metal cylinder having a diameter of 17 mm, and thereafter sintered in air at 800° C. for 24 hours, to thus obtain a sintered material of LiCoO₂. This was pulverized in a mortar into particles having an average particle size of 20 μm.

Then, 90 parts by weight of the resultant LiCoO₂ powder and 5 parts by weight of artificial graphite powder, serving as a conductive agent, were mixed with a 5 weight % N-methylpyrrolidone solution containing 5 parts by weight of polyvinylidene fluoride, serving as a binder agent, to thus prepare a positive electrode mixture slurry.

The resultant positive electrode mixture slurry was applied onto an aluminum foil current collector, then dried, and thereafter pressure-rolled. The resultant material was cut out into a 20 mm×20 mm square shape, to thus form a positive electrode.

Preparation of Electrolyte Solution

LiPF₆ was dissolved into a mixed solvent of 3:7 volume ratio of ethylene carbonate and diethyl carbonate, at a concentration of 1 mole/liter, and carbon dioxide was blown into the resultant solution to dissolve carbon dioxide therein. Thus, an electrolyte solution was prepared.

Construction of Battery

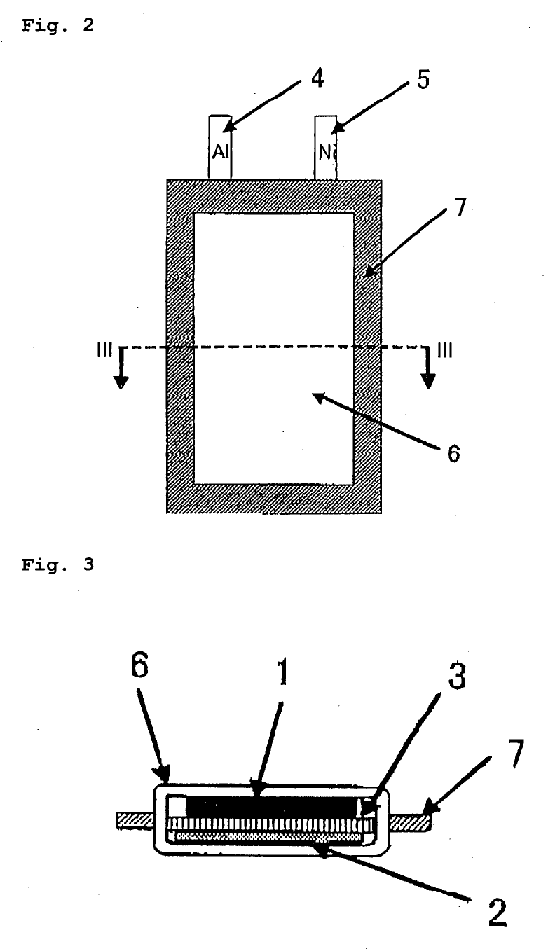

The foregoing electrode C1, the positive electrode, and the electrolyte solution, which were prepared in the above-described manner, were placed into a battery case made of an aluminum laminate, and thus, a lithium secondary battery A1 as illustrated in FIGS. 2 and 3 was fabricated.

Lithium secondary batteries A2, A3, B1, and B2 were fabricated in the same manner as used for the battery A1, expect that the respective batteries used the negative electrodes C2, C3, C4, and C5, respectively.

FIG. 3 is a cross-sectional view taken along line III-III in FIG. 2. As illustrated in FIG. 3, in the fabricated lithium secondary batteries, the positive electrode 1 and the negative electrode 2 oppose each other across a porous polyethylene separator 3. In the battery, the positive electrode 1 and the negative electrode 2 are respectively connected to a positive electrode tab 4 made of aluminum and a negative electrode tab 5 made of nickel, forming a structure capable of charging and discharging as a secondary battery.

As illustrated in FIG. 2, the periphery of the aluminum laminate battery case 6 is heat-sealed to form a sealed part 7. The positive electrode tab 4 and the negative electrode tab 5 are extended out through the sealed part 7.

Charge-Discharge Test

The charge-discharge cycle performance of each of the batteries A1 to A3 as well as B1 and B2, fabricated in the manner described above, was evaluated as follows. Each of the batteries was charged at 25° C. with a current of 14 mA to 4.2 V, then further charged until the current became 0.7 mA while the voltage was being kept at 4.2 V, and thereafter discharged with a current of 14 mA to 2.75 V. This charge-discharge process was taken as one cycle. The initial deterioration, the capacity retention ratio, and the negative electrode expansion ratio for each battery are shown in Table 1 below.

The initial deterioration is defined as the discharge capacity of the battery after the 50th cycle with respect to the discharge capacity at the first cycle. The capacity retention ratio is defined as the discharge capacity after the 250th cycle with respect to the discharge capacity at the first cycle. The negative electrode expansion ratio is defined as the ratio of the thickness of the negative electrode discharged to 2.75 V with reference to the thickness of the negative electrode charged to 4.2 V.

The “particle size distribution” shown in Table 1 is the volume percent of the negative electrode active material particles that fall within the ±40% range of the average particle size for each battery. The negative/positive electrode capacity ratio means the ratio of the negative electrode specific capacity/the positive electrode specific capacity. The negative/positive electrode capacity ratio for each battery was obtained by measuring the negative electrode specific capacity and the positive electrode specific capacity using a three-electrode cell, which was prepared separately, that has one of the foregoing negative electrodes or the foregoing positive electrode as its working electrode. The electrolyte solution used for the three-electrode cell was the same electrolyte solution as the foregoing electrolyte solution. Metallic lithium was used for the counter electrode and the reference electrode.

TABLE 1

| | | | | | Capacity | Negative |
|---|---|---|---|---|---|---|
| | Average | Particle size | Negative/positive | Initial | retention | electrode |
| | particle size | distribution | electrode capacity | deterioration | ratio | expansion |
| | (μm) | (vol. %) | ratio | (%) | (%) | ratio (times) |
| A1 | 7.5 | 82 | 2.4 | 92 | 67 | 1.4 |
| A2 | 10 | 83 | 2.3 | 90 | 65 | 1.4 |
| A3 | 15 | 80 | 2.5 | 86 | 65 | 1.8 |
| B1 | 5.5 | 80 | 2.5 | 95 | 22 | 1.3 |
| B2 | 20 | 79 | 2.6 | 72 | 55 | 2 |

As seen from Table 1, the batteries A1 to A3 are example batteries according to the present invention. In the battery B1, the negative electrode active material particles have an average particle size less than the lower limit specified in the present invention, so the battery B1 is a comparative example battery. In the battery B2, the negative electrode active material particles have an average particle size greater than the upper limit specified in the present invention, so the battery B2 is also a comparative example battery.

The results shown in Table 1 clearly demonstrate that the example batteries A1 to A3 according to the present invention show small initial deteriorations and high capacity retention ratios. The comparative example battery B1 shows a lower capacity retention ratio, which means that the charge-discharge cycle performance is poor. The comparative example battery B2 shows a greater negative electrode expansion ratio than those of the example batteries A1 to A3.

From the foregoing discussion, it will be appreciated that good charge-discharge cycle performance can be obtained and at the same time the expansion of the negative electrode can be minimized by controlling the average particle size of the negative electrode active material particles to be within the range specified by the present invention.

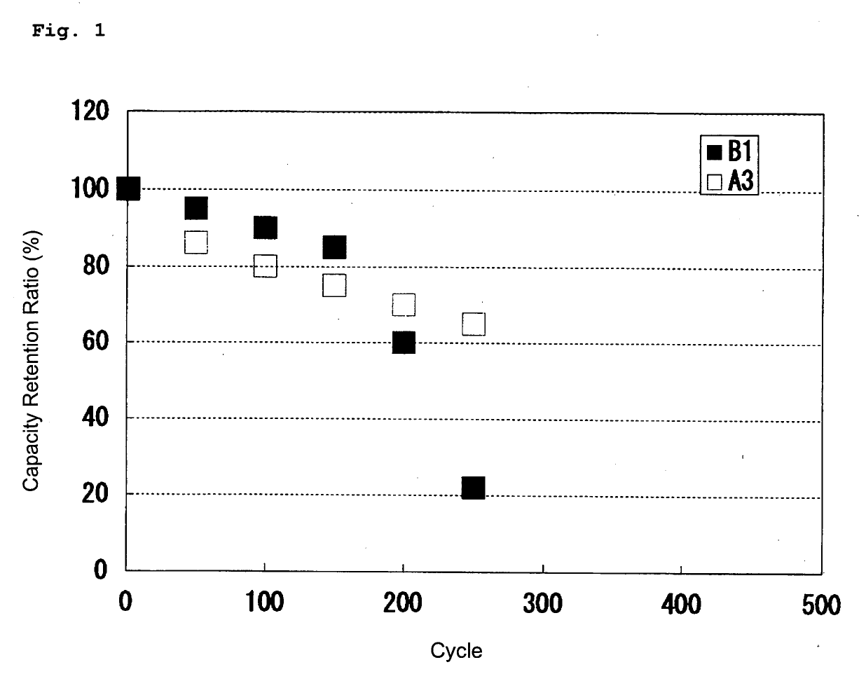

FIG. 1 is a graph showing the capacity retention ratios of the example battery A3 and the comparative example battery B1 at various numbers of cycles. As seen from FIG. 1, the battery B1, which uses the negative electrode active material particles having an average particle size lower than the range specified by the present invention, shows a significant drop in the capacity retention ratio after the 200th cycle, although it shows higher capacity retention ratios than the example battery A3 up to less than the 200th cycle.

### Experiment 2

### Preparation of Comparative Negative Electrode

A negative electrode C6 was prepared in the same manner as foregoing negative electrode C1, except that the negative electrode active material used had an average particle size of 7.5 μm and was such that 50 volume % of the silicon powder particles falls within the ±40% range of the average particle size.

Preparation of Comparative Battery

A lithium secondary battery B3 was fabricated in the same manner as battery A1, except that the just-described negative electrode C6 was used as the negative electrode.

Charge-Discharge Test

The batteries A1 and B3 were subjected to the charge-discharge test under the same conditions as described in Experiment 1 to obtain the initial deteriorations and the capacity retention ratios. The results are shown in Table 2 below.

TABLE 2

| | Average | | | | Capacity |
|---|---|---|---|---|---|
| | particle | Particle size | Negative/positive | Initial | retention |
| | size | distribution | electrode | deterioration | ratio |
| | (μm) | (vol. %) | capacity ratio | (%) | (%) |
| A1 | 7.5 | 82 | 2.4 | 92 | 67 |
| B3 | 7.5 | 50 | 2.3 | 95 | 50 |

As clearly seen from Table 2, battery B3, in which less than 60 volume % of the active material particles is within the ±40% range of the average particle size, shows a poor capacity retention ratio. Accordingly, it is demonstrated that the use of the active material particles having a particle size distribution such that 60 volume % or greater of the particles falls within the ±40% range of the average particle size according to the present invention can enhance the charge-discharge cycle performance.

### Experiment 3

### Preparation of Negative Electrode

A negative electrode C7 was prepared in the same manner as negative electrode C1, except that the weight of the active material layer was 0.52 times that of the negative electrode C1. Also, a negative electrode C8 was prepared in the same manner as negative electrode C1, except that the weight of the active material layer was 0.8 times that of the negative electrode C1.

Construction of Battery

A lithium secondary battery B4 was fabricated in the same manner as battery A1, except that the just-described negative electrode C7 was used as the negative electrode. The battery B4 uses the negative electrode C7, in which the weight of the active material layer is 0.52 times that of the negative electrode C1, and therefore has a negative/positive electrode capacity ratio of 1.3. Also, a lithium secondary battery A4 was fabricated in the same manner as battery A1, except that the just-described negative electrode C8 was used as the negative electrode. The battery A4 has a negative/positive electrode capacity ratio of 1.9 because the weight of the active material layer is 0.8 times that of the negative electrode C1.

Charge-Discharge Test

The batteries A1 and B4 were subjected to a charge-discharge test under the same conditions as described in Experiment 1, to measure their initial stage deteriorations and capacity retention ratios. The results are shown in Table 3 below.

TABLE 3

| | Negative/positive | Initial | Capacity |
|---|---|---|---|
| | electrode capacity | deterioration | retention ratio |
| | ratio | (%) | (%) |
| A1 | 2.4 | 92 | 67 |
| A4 | 1.9 | 93 | 60 |
| B4 | 1.3 | 62 | 22 |

The results shown in Table 3 clearly demonstrate that the comparative battery B4, in which the negative/positive electrode capacity ratio is less than 1.7, shows a larger initial deterioration and a smaller capacity retention ratio. It is believed that the reason is as follows. When the negative/positive electrode capacity ratio is less than 1.7, the charge depth of the negative electrode becomes about 60% or higher and the negative electrode utilization factor becomes high. Therefore, the active material particles tend to break more easily due to expansion and shrinkage in the volume thereof associated with charge-discharge reactions. Accordingly, by controlling the negative/positive electrode capacity ratio to be 1.7 or greater according to the present invention, deterioration of the active material can be minimized, and good charge-discharge cycle performance can be obtained.

As has been described, the present invention makes available a lithium secondary battery that shows excellent charge-discharge cycle performance over a long period of time, minimizes the swelling of the negative electrode that results from charge-discharge operations, and has a high energy density and excellent cycle performance.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and is not intended to limit the invention as defined by the appended claims and their equivalents.

This application claims priority of Japanese patent application No. 2006-053127 filed Feb. 28, 2006, which is incorporated herein by reference.

What is claimed is:

1. A lithium secondary battery comprising:
a positive electrode comprising a positive electrode active material;
a negative electrode comprising an active material layer; and a current collector made of a conductive metal foil, the active material layer comprising a binder and active material particles that contain silicon, and being formed by sintering the active material layer on a surface of the current collector in a non-oxidizing atmosphere, the active material particles having an average particle size of from 7.5 μm to 15 μm and a particle size distribution such that 60 volume % or more of the active material particles falls within the ±40% range of the average particle size; and
a non-aqueous electrolyte, wherein
the lithium secondary battery has a negative/positive electrode capacity ratio of 1.7 or greater, the negative/positive electrode capacity ratio being defined as the ratio of negative electrode specific capacity/positive electrode specific capacity, wherein the negative electrode specific capacity is a negative electrode capacity per unit area that is obtained, using a three-electrode cell in which the negative electrode and Li oppose each other, by passing a current through the three-electrode cell so that the potential changes from 1 m V (vs. Li/Li⁺) to 1000 mV (vs. Li/Li⁺), and the positive electrode specific capacity is a positive electrode capacity per unit area that is obtained, using a three-electrode cell in which the positive electrode and Li oppose each other, by passing a current through the three-electrode cell so that the potential changes from 4.4 V (vs. Li/Li⁺) to 3.0 V (vs. Li/Li⁺).

2. The lithium secondary battery according to claim 1, wherein the active material particles are silicon particles.

3. The lithium secondary battery according to claim 1, wherein the binder comprises a polyimide.

4. The lithium secondary battery according to claim 2, wherein the binder comprises a polyimide.
